(19) United States
(12) Patent Application Publication
(10) Pub. No.: US 2021/0389712 A1
(43) Pub. Date: Dec. 16, 2021

(54) IMAGE FORMING SYSTEM, IMAGE INSPECTION DEVICE, ABNORMALITY DETECTION LEVEL SETTING METHOD, AND PROGRAM

(71) Applicant: KONICA MINOLTA, INC., Tokyo (JP)

(72) Inventor: Akio UEDA, Tokyo (JP)

(73) Assignee: KONICA MINOLTA, INC., Tokyo (JP)

(21) Appl. No.: 17/241,153

(22) Filed: Apr. 27, 2021

(30) Foreign Application Priority Data
Jun. 10, 2020 (JP) 2020-100822

(51) Int. Cl. G03G 15/00; G06T 7/00

(52) U.S. Cl. CPC G03G 15/5062; G06T 7/0004; G03G 15/5029; G03G 15/55

(57) ABSTRACT

An image forming system includes: an image former that forms a printed image on a recording medium on the basis of setting information included in a print job and original image data; an image reader that generates read image data by optically reading the printed image; an abnormality detector that detects an abnormality included in the printed image using the read image data; a storage that stores a plurality of pieces of read image data in each of which the abnormality has been detected as sample image data, and stores at least one feature parameter representing a feature of the print job in association with corresponding sample image data; a hardware processor that searches for a feature parameter and sets an abnormality detection level in the abnormality detector; and an acceptor that accepts user's evaluation for an abnormality included in the displayed sample image data.

The entire disclosure of Japanese patent Application No. 2020-100822, filed on Jun. 10, 2020, is incorporated herein by reference in its entirety.

### BACKGROUND

### Technological Field

The present disclosure relates to an image forming system, an image inspection device, an abnormality detection level setting method, and a program.

### Description of the Related Art

In order to determine the quality of an image printed on paper, an algorithm that detects an abnormality included in the image by optically reading the image on the paper is known. In the abnormality detection algorithm, a detection parameter that serves as a reference for determining whether the image is abnormal or normal, that is, an abnormality detection level is set.

Regarding setting of the abnormality detection level, for example, JP 2017-191979 A discloses an image forming system “including: an image forming device including an image forming unit that forms an image on paper; an image reading unit that reads the paper surface and generates a scanned image; an image inspection unit that detects an abnormality in the scanned image, and a history generation unit that embeds detection information of each detected abnormality in the scanned image and generates a history image; a storage device that stores the history image; and a user terminal that displays an abnormality detection result by the image inspection unit using the history image and inputs user's evaluation for the abnormality detection result, in which the image forming device further includes a parameter setting unit that finally determines an abnormality in the scanned image according to the user's evaluation, detects the finally determined abnormality, and determines and sets an abnormality detection parameter so as not to detect an abnormality that has not been finally determined” (see [Summary]).

Whether or not a user tolerates an abnormality included in an image printed on paper depends on a feature of the printed image. For example, the user's tolerance may be different between a case where the printed image includes only “characters” and a case where the printed image includes only “photographs” even if the abnormalities thereof are at the same detection level.

Therefore, in a case where the abnormality detection level is set on the basis of user's evaluation for a sample image including an abnormal portion as described in JP 2017-191979 A, it is necessary to display an appropriate sample image according to a feature of a print job to be executed. For example, in a case where an image including only “characters” is printed, it is appropriate to display a sample image including only “characters”, and it is inappropriate to display a sample image including only “photographs”.

### SUMMARY

The present disclosure has been achieved in view of the above background. According to an aspect, in a case where an abnormality detection level is set on the basis of user's evaluation for a sample image including an abnormal portion, a technique of displaying an appropriate sample image according to a feature of a print job to be executed is disclosed.

To achieve the abovementioned object, according to an aspect of the present invention, an image forming system reflecting one aspect of the present invention comprises: an image former that forms a printed image on a recording medium on the basis of setting information included in a print job and original image data; an image reader that generates read image data by optically reading the printed image; an abnormality detector that detects an abnormality included in the printed image using the read image data; a storage that stores a plurality of pieces of read image data in each of which the abnormality has been detected as sample image data, and stores at least one feature parameter representing a feature of the print job in association with corresponding sample image data; a hardware processor that searches for a feature parameter that is similar or identical to a feature of a print job to be executed from the plurality of feature parameters stored in the storage and sets an abnormality detection level in the abnormality detector on the basis of the user's evaluation; a display that displays sample image data associated with the found feature parameter; and an acceptor that accepts user's evaluation for an abnormality included in the displayed sample image data.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of a hardware configuration of an image forming system;

FIG. 2 is a diagram illustrating an example of a detailed hardware configuration of an image forming device and an image inspection device of FIG. 1;

FIG. 3 is a diagram illustrating an example of a detailed hardware configuration of a controller of FIG. 2;

FIG. 4 is a diagram illustrating an example of a detailed hardware configuration of a client terminal of FIG. 1;

FIG. 5 is a functional block diagram for explaining a process executed by the image inspection device in the image forming system;

FIG. 6 is a diagram illustrating an example of a figure area ratio and a character area ratio in a table format for a selected page of a print job to be executed and a plurality of sample images;

FIG. 7 is a flowchart illustrating an example of a procedure for setting an image abnormality detection level in an image forming system of a first embodiment;

FIG. 8 is a diagram illustrating an example of a job list screen displayed on an operation panel for accepting selection of a print job from a user;

FIG. 9 is a diagram illustrating an example of a job ticket editing screen displayed on the operation panel in step S610, 615 in order to accept user's page selection and an instruction to search for a suitable sample image;

FIG. 10 is a diagram illustrating an example of a suitable sample image display screen displayed on a display in order to inquire a user whether or not to tolerate an abnormality included in the suitable sample image;

FIG. 11 is a diagram illustrating an example of the suitable sample image display screen displayed on the display in order to inquire a user whether or not to tolerate an abnormality included in the suitable sample image;

FIG. 12 is a flowchart illustrating an example of a procedure for setting an image abnormality detection level in an image forming system of a second embodiment;

FIG. 13 is a diagram clearly illustrating an area where an abnormality has been further detected in FIG. 6;

FIG. 14 is a flowchart illustrating an example of a procedure for setting an image abnormality detection level in an image forming system of a third embodiment;

FIG. 15 is a diagram illustrating an example of a screen displaying a list of results of classifying pages of an execution job according to an image area ratio and a character area ratio included in a bitmap format image based on original image data;

FIG. 16 is a flowchart illustrating an example of a procedure for setting an image abnormality detection level in an image forming system of a fourth embodiment; and

FIG. 17 is a flowchart illustrating an example of a procedure for setting an image abnormality detection level in an image forming system of a fifth embodiment.

### DETAILED DESCRIPTION OF EMBODIMENTS

Hereinafter, one or more embodiments of the present invention will be described with reference to the drawings. However, the scope of the invention is not limited to the disclosed embodiments. In the following description, the same components are denoted by the same reference numeral. The names thereof and the functions thereof are also the same. Therefore, detailed description thereof will not be repeated. In a case where a number, quantity, and the like are referred to, the scope of the present disclosure is not necessarily limited to the number, quantity, and the like unless otherwise specified. In a case where a plurality of same components are referred to, the same components may be expressed by adding A, B, . . . to an end of a reference numeral, such as a component 123A or 123B. In a case where the components 123A, 123B, and the like are generically referred to, the components 123A, 123B, and the like are expressed as a component 123.

Hereinafter, paper is used as an example of a recording medium, but a recording medium made of a material other than paper may be used instead of the paper.

### First Embodiment

[Outline of Hardware Configuration of Printing System and Operation Thereof]

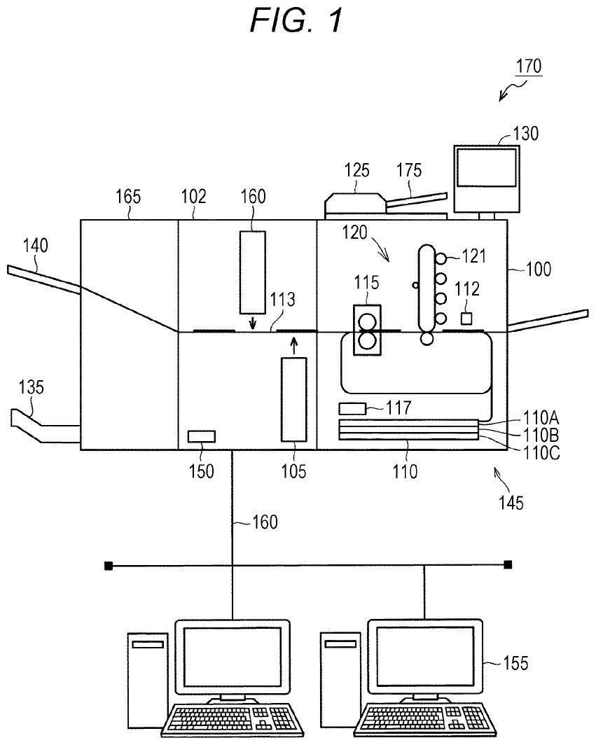

First, with reference to FIGS. 1 to 4, an outline of a hardware configuration of an image forming system 170 in the present embodiment and an operation thereof will be described. FIG. 1 is a diagram illustrating an example of the hardware configuration of the image forming system 170.

As illustrated in FIG. 1, the image forming system 170 includes an image forming device 100, an image inspection device 102, at least one client terminal 155, a communication line 160, and a post-processing device 165. The image forming device 100, the image inspection device 102, and the post-processing device 165 are connected in series. In another aspect, the image forming system 170 does not have to include the post-processing device 165. In still another aspect, the image inspection device 102 may be a single image inspection device independent of the image forming device 100.

The image forming device 100 forms a printed image on paper fed from a paper feed tray 110 on the basis of original image data of a print job designated by a user. More specifically, a printer controller (not illustrated) generates bitmap data by performing a rasterization process on original image data described in page description language (PDL). The image forming device 100 forms a printed image on paper on the basis of the generated bitmap data. The rasterization process is a process of converting image and character data described in PDL into bitmap data. Note that in the present disclosure, the image includes a character, a figure, a photograph, a barcode, and the like.

The print job includes original image data and setting information. The setting information includes a job ticket which is control data that defines various conditions for image formation, post-processing, and the like in the print job. As an example, the job ticket includes setting information regarding the size, paper type, basis weight, and physical property values of paper to be printed, the number of copies, a data file used for printing, the number of pages, a user name, double-sided/single-sided printing, paper selection, magnification, the number of copies to be output, the amount of shift of an image, the position of a stamp, imposition information, image quality adjustment, a post-process performed in the print job, and the like.

In the example of FIG. 1, the image forming device 100 includes the paper feed tray 110, a media sensor 112, a controller 117, an image former 120, a scanner 125, an operation panel 130, and a document feeder (DF) 175. The detailed configuration of the operation panel 130 and the image forming device 100 will be described later.

The paper feed tray 110 accommodates paper. A type of paper designated by the print job is taken out one by one from the paper feed tray 110 and fed to the image former 120 by a transport mechanism (not illustrated).

In the example of FIG. 1, the paper feed tray 110 includes a plurality of paper feed trays 110A, 110B, and 110C, and the paper feed trays 110 accommodate a plurality of types of paper having different sizes, paper qualities, basis weights (g/m²), paper physical property values described later, and the like.

The media sensor 112 is an optical sensor for detecting a physical property value of paper passing through a transport path 113. The media sensor 112 is disposed in the paper transport path 113, and can detect paper physical property values such as the surface property, paper thickness, and basis weight of the paper from transmittance, reflectance, and the like when the paper is exposed to light. In another aspect, the media sensor 112 may be externally attached to the image forming device 100.

The transport path 113 is a path through which a recording medium passes in the image forming device 100 and the image inspection device 102.

The controller 117 controls an operation of the image forming device 100. As an example, the controller 117 controls an operation of the image former 120.

The image former 120 includes a fixing unit 115 and a toner image forming unit 121. The fixing unit 115 heats and pressurizes paper on which a toner image has been formed by the toner image forming unit 121. The toner image forming unit 121 forms an image including four color toners of yellow (Y), magenta (M), cyan (C), and key plate (K) on paper by an electrophotographic method. In a case where images are formed on both surfaces of paper, after an image is formed on one surface, a direction in which the paper is transported is changed by a transport roller (not illustrated). The paper is fed to the toner image forming unit 121 again, and an image is formed on the other surface.

In another aspect, the image former 120 may be a unit that forms a monochrome image instead of a color image. In still another aspect, the image former 120 may form an image on paper by, for example, an inkjet method, and a method for forming an image is not particularly limited.

In an aspect, by scanning paper set in the DF 175 by a user, the scanner 125 acquires input image data in the print job. As an example, the scanner 125 may be achieved by a charge coupled device (CCD) sensor.

By reading an image formed on paper, the image inspection device 102 inspects presence or absence of an abnormality in the image. The image inspection device 102 includes a scanner 105, 106 for reading an image formed on each surface of paper by the image forming device 100. The scanner 105, 106 is disposed on a downstream side of the image forming device 100 in the paper transport path 113, read an image formed on the paper, and generate a read image corresponding to the read surface. For example, in a case where the scanner 105 reads an image on a lower surface of paper, the scanner 106 reads an image on an upper surface of the paper. The scanner 105, 106 is, for example, a sensor that receives light emitted from a light source and reflected on a surface of paper with a light receiving element and outputs a signal according to the intensity of the light. The scanner 105, 106 may be formed by a line sensor in which a plurality of light receiving elements is disposed at predetermined intervals in a direction orthogonal to a paper transport direction, or may read only a predetermined area in a direction orthogonal to the paper transport direction. The detailed configuration of the image inspection device 102 will be described later.

In the example of FIG. 1, the image inspection device 102 includes a controller 150 in a housing thereof. The controller 150 controls an operation of the image inspection device 102.

The client terminal 155 transmits the print job executed by the image forming device 100 to the image forming device 100 via the communication line 160. In an aspect, by operating the client terminal 155, a user can input or change setting information in the print job. The setting information in the print job includes, as an example, various settings such as a paper size, a paper basis weight, a paper type, a paper physical property value, a user name, and the number of prints. In an aspect, the client terminal 155 can be achieved by an information processing device such as a personal computer (PC), a smartphone, or a tablet terminal.

The post-processing device 165 performs a post-process such as stapling, center folding, three folding, saddle stitching, or punching on paper inspected by the image inspection device 102 according to the print job on the basis of an instruction from the controller 117 In a case where the print job does not include an instruction regarding the post-process, the post-processing device 165 does not perform the post-process on the paper and discharges the paper to a paper discharge tray 140. On the other hand, when the print job includes an instruction regarding the post-process, the post-processing device 165 performs the designated post-process on the paper and then discharges the paper to a paper discharge tray 135.

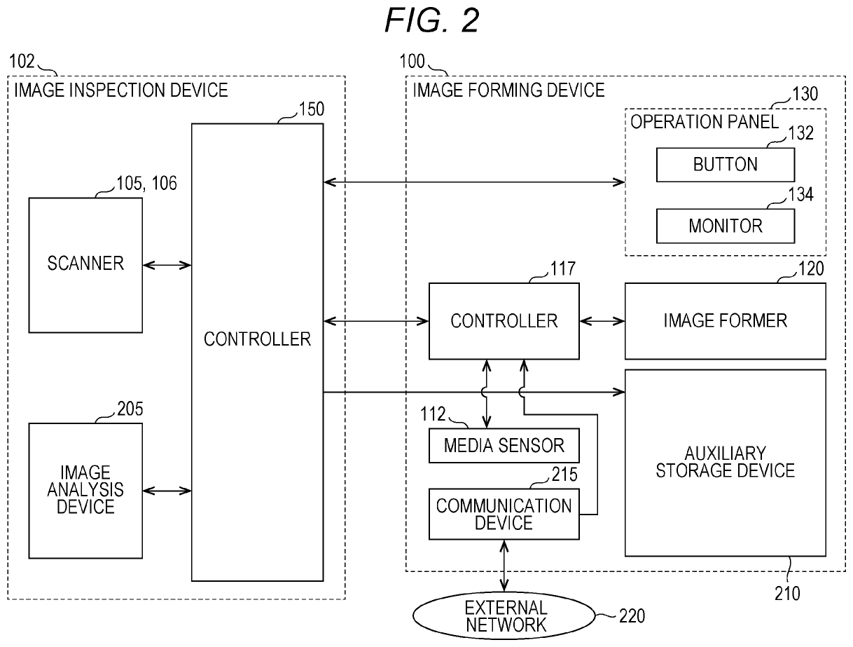

FIG. 2 is a diagram illustrating an example of a detailed hardware configuration of the image forming device 100 and the image inspection device 102 in FIG. 1. First, the image forming device 100 will be described.

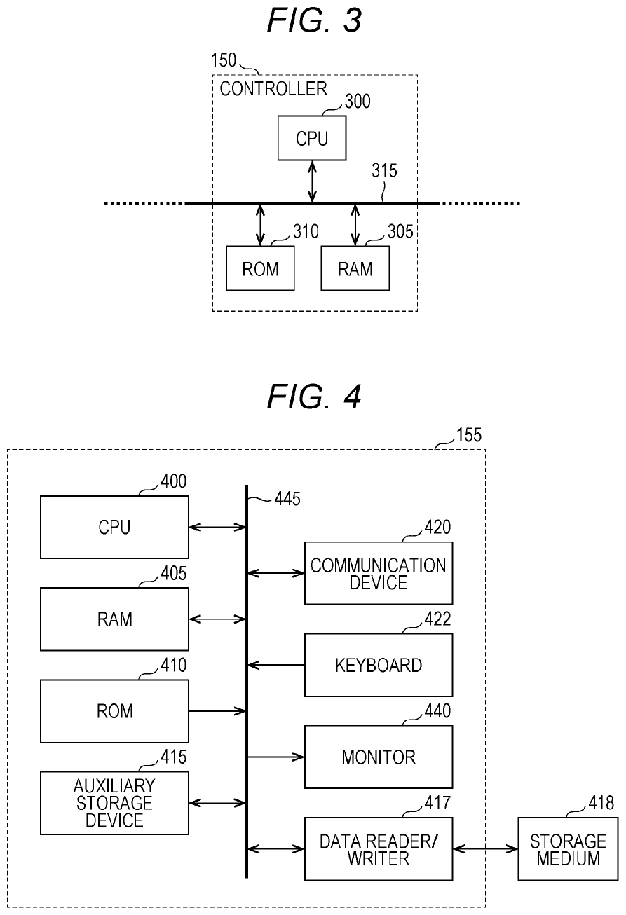

The image forming device 100 includes the media sensor 112, the controller 117, the operation panel 130, the image former 120, an auxiliary storage device 210, and a communication device 215. Note that for the sake of simplicity, the paper feed tray 110, the fixing unit 115, the scanner 125, the DF 175, and the like illustrated in FIG. 1 are not illustrated in FIG. 2. Description of the media sensor 112 and the image former 120 already described with reference to FIG. 1 will not be repeated. The detailed configuration of the controller 117 will be described later with reference to FIG. 3.

In an aspect, the operation panel 130 includes a button 132 and a monitor 134. The operation panel 130 is, for example, a touch screen incorporating a touch sensor and having a plurality of buttons.

More specifically, the button 132 accepts an input of an operation on the image forming device 100. The button 132 may be either a physical key or a software key. The button 132 is operated, as an example, for selecting a print job, setting whether or not to execute an abnormality detection process, and setting setting information regarding the print job, such as the basis weight, size, and paper type of paper on which an image is formed. When the button 132 is operated, the button 132 transmits a signal corresponding to each button to the controller 117.

The controller 117 determines an operation content of a user on the basis of a signal received from the button 132, executes an internal operation according to the operation content, and transmits a response display to the monitor 134.

The monitor 134 displays an operation screen and the like on the basis of a signal received from the controller 150. As an example, the monitor 134 is a liquid crystal monitor or the like, and displays an operation menu. The controller 150 determines an operation content of a user on the basis of a signal received from the button 132, executes an internal operation according to the operation content, and transmits a response display to the monitor 134.

The auxiliary storage device 210 non-volatilely stores various types of data and the like regarding operations of the image forming device 100 and the image inspection device 102. The auxiliary storage device 210 stores various programs and data used in the image forming device 100 and the image inspection device 102. In an aspect, the auxiliary storage device 210 is achieved by a hard disk drive (HDD), a solid state drive (SSD), a digital versatile disk-read only memory (DVD), a magnetic disk, an optical disk, a universal serial bus (USB) memory, and the like.

The communication device 215 transmits/receives data to/from another device such as the client terminal 155 of FIG. 1. The image forming device 100 may include a plurality of the communication devices 215. In an aspect, the communication device 215 may include any or all of a Local Area Network (LAN) port, Wireless Fidelity (Wi-Fi) (registered trademark) transmitter/receiver, and the like. The image forming device 100 can acquire a print job from the client terminal 155 such as a PC, which is another device, connected to an external network 220 via the communication device 215.

Next, the image inspection device 102 will be described. The image inspection device 102 includes the scanner 105, 106, the controller 150, and an image analysis device 205. Description of the scanner 105, 106 already described with reference to FIG. 1 will not be repeated. The controller 150 will be described later with reference to FIG. 3.

The image analysis device 205 can perform image analysis such as pattern recognition with artificial intelligence (AI) technology. As an example, by analyzing an image read by the scanner 105, 106 (hereinafter, also referred to as “read image”), the image analysis device 205 determines presence or absence of an abnormality in the image. The abnormality includes, for example, color shift, misalignment, and stain.

As an example, by comparing the read image with a correct image corresponding to the read image, the image analysis device 205 determines a density difference between the read image and the correct image. The correct image may be a read image formed on paper and determined to have no abnormality, or may be original image data. In a case where an area where the density difference is equal to or higher than a predetermined threshold exists, the image analysis device 205 determines that an abnormality exists in the area.

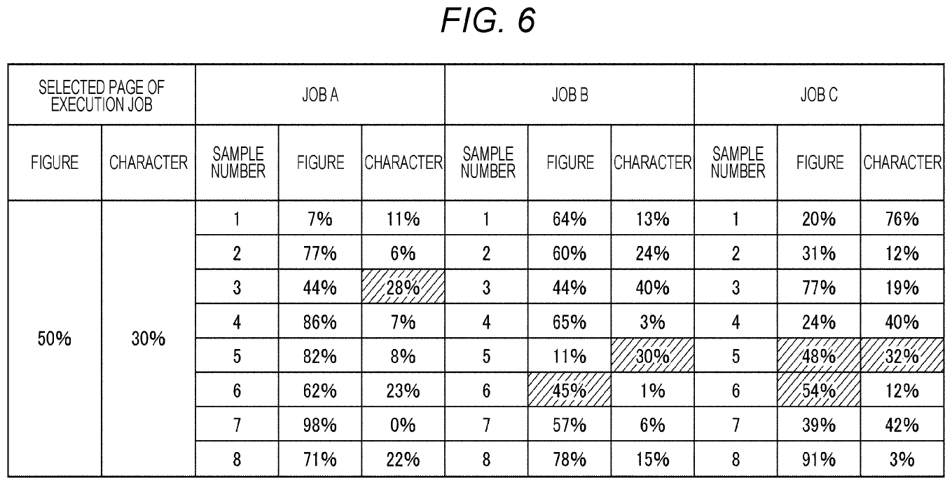

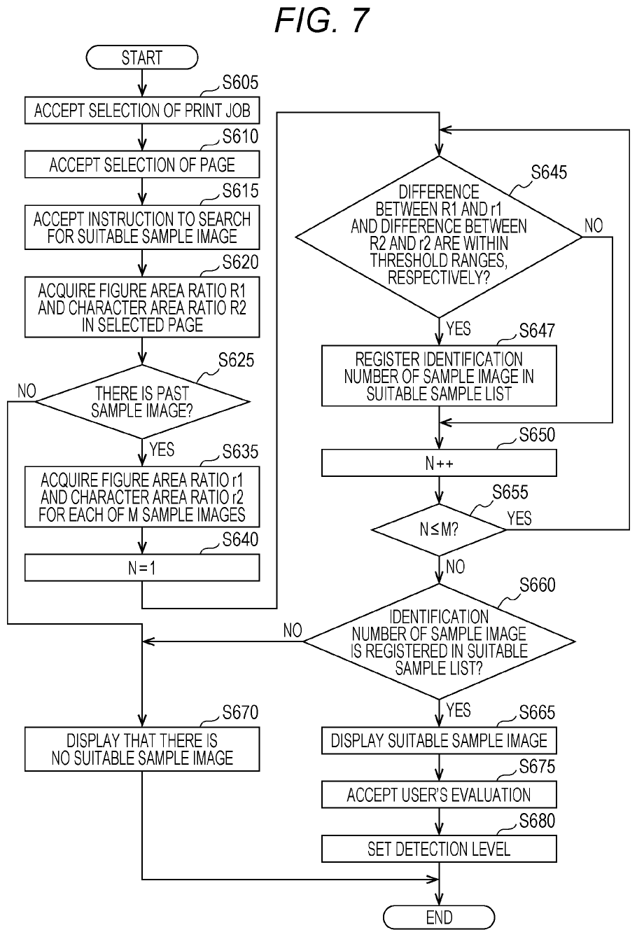

Furthermore, the image analysis device 205 can classify an image to be analyzed into a plurality of areas such as a character area and an image area. A process of dividing an area will be described later with reference to FIG. 6.

In the example of FIG. 2, the auxiliary storage device 210 and the communication device 215 are included in a housing of the image forming device 100. In another aspect, the auxiliary storage device 210 and the communication device 215 may be included not only in the housing of the image forming device 100 but also in the housing of the image inspection device 102.

FIG. 3 is a diagram illustrating an example of a detailed hardware configuration of the controller 117 of FIG. 2. As illustrated in FIG. 3, the controller 117 includes a central processing unit (CPU) 300, a random access memory (RAM) 305, and a read-only memory (ROM) 310. In another aspect, the controller 117 may further include an electrically rewritable non-volatile memory such as a flash memory.

The CPU 300 executes a program for controlling the image forming device 100. As an example, the CPU 300 executes a program for displaying an operation screen and reading data stored in the auxiliary storage device 210. The CPU 300 is connected to the RAM 305 and the ROM 310 via a bus 315. In another aspect, the controller 150 may include at least one incorporated CPU, at least one application specific integrated circuit (ASIC), at least one field programmable gate array (FPGA), or a combination thereof.

The RAM 305 temporarily stores a program executed by the CPU 300 and data referred to. The CPU 300 reads a program or various types of data stored in the ROM 310 into the RAM 305 for execution. In an aspect, the RAM 305 may be achieved by a static random access memory (SRAM) or a dynamic random access memory (DRAM).

The ROM 310 stores a program for controlling the image forming device 100, various types of data prepared in advance by a manufacturer of the image forming device 100, and the like. The ROM 310 may store image data read by the scanner 105, 106.

Although not illustrated in FIG. 3, like the controller 117, the controller 150 includes a CPU, a RAM, a ROM, and a bus. The configurations of the CPU, RAM, ROM, and bus forming the controller 150 are similar to the configurations of the CPU 300, RAM 305, ROM 310, and bus 315 forming the controller 117, respectively. Therefore, description of the above elements forming the controller 150 will not be repeated.

FIG. 4 is a diagram illustrating an example of a detailed hardware configuration of the client terminal 155 of FIG. 1.

As illustrated in FIG. 4, the client terminal 155 includes a CPU 400, a RAM 405, a ROM 410, an auxiliary storage device 415, a data reader/writer 417, a communication device 420, a keyboard 422, a monitor 440, and a bus 445.

The CPU 400 controls an operation of the entire client terminal 155. As an example, the CPU 400 transmits a print job to the image forming device 100 via the communication device 420.

The configurations of the RAM 405, ROM 410, auxiliary storage device 415, communication device 420, and bus 445 are similar to the configurations of the RAM 305, ROM 310, auxiliary storage device 210, communication device 215, and bus 315 forming the image forming device 100, respectively. Therefore, description thereof will not be repeated.

An external storage medium 418 such as an external HDD is detachably attached to the data reader/writer 417. The data reader/writer 417 writes data including an image or a program to the attached storage medium 418 or reads data from the storage medium 418 on the basis of an instruction from the CPU 400. The storage medium 418 stores information of recorded program or the like by electrical, magnetic, optical, mechanical, or chemical action such that a computer or another device can read the information of the program or the like. The data reader/writer 417 may be disposed in the image forming device 100.

The keyboard 422 is a device used by a user for operating the client terminal 155. In another aspect, the client terminal 155 may include a mouse instead of the keyboard 422 as the device.

The monitor 440 displays information on the basis of an instruction from the CPU 400. In an aspect, a liquid crystal panel or an organic electro-luminescence (EL) display is used as the monitor 440.

[Setting of Abnormality Detection Level]

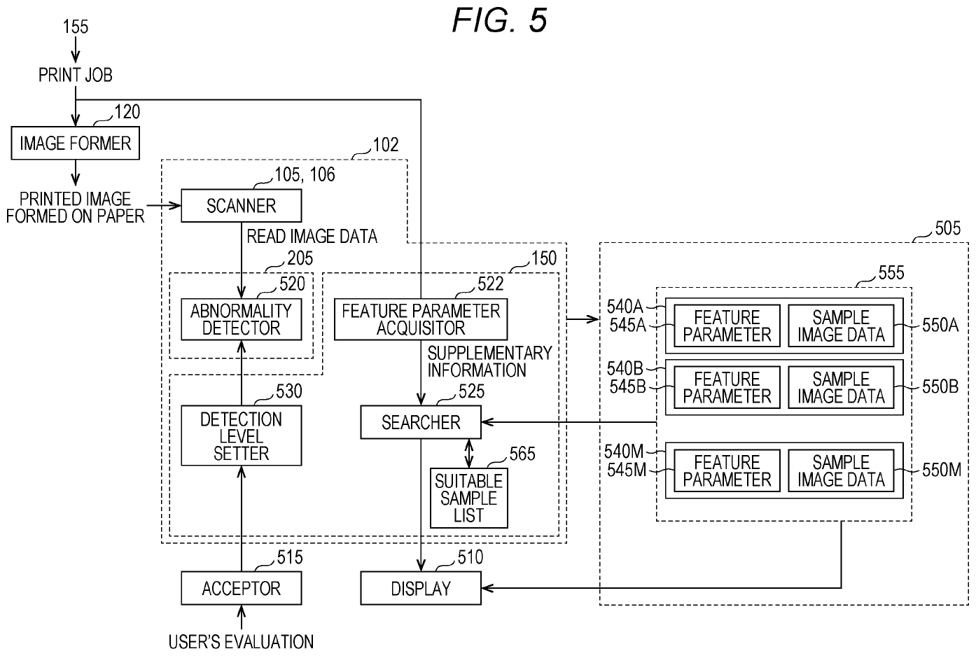

With reference to FIG. 5, in the image forming system 170 of the first embodiment, a process for setting an abnormality detection level of a printed image will be described. FIG. 5 is a functional block diagram for explaining a process executed by the image inspection device 102 in the image forming system 170.

As specifically described below, processes executed by the image inspection device 102 can be roughly divided into two. As a first process, the image inspection device 102 determines whether or not a printed image includes an abnormal portion on the basis of read image data generated by the scanner 105, 106. Then, when the image inspection device 102 detects a printed image including an abnormal portion, the image inspection device 102 stores corresponding read image data as sample image data in the storage 505 achieved by the auxiliary storage device 210 or the like. As a result, a database including a large number of pieces of sample image data is generated. Here, the sample image data is stored in the storage together with information representing a feature of a corresponding print job (hereinafter, referred to as a feature parameter).

As a second process, the image inspection device 102 selects a sample image suitable for user's evaluation from the database on the basis of a print job to be executed, and displays the sample image on the display. The above feature parameter is used to select the sample image. The image inspection device 102 sets an abnormality detection level on the basis of the user's evaluation for the sample image.

Hereinafter, the first process (database generation process) and the second process (abnormality detection level setting process) described above will be described in detail.

(Database generation process)

The image inspection device 102 includes an abnormality detector 520, a feature parameter acquisitor 522, a searcher 525, and a detection level setter 530 as a functional configuration thereof. The function of the abnormality detector 520 is included in the function of the image analysis device 205. The functions of the feature parameter acquisitor 522, the searcher 525, and the detection level setter 530 are achieved by an operation of the CPU of the controller 150 according to a program stored in the ROM.

The abnormality detector 520 detects an abnormality included in a printed image formed on paper by the image former 120. Specifically, the abnormality detector 520 detects an abnormal portion by comparing read image data generated by the scanner 105, 106 from the printed image with correct image data by using an image processing technique. In a case where the abnormality detector 520 detects an abnormal portion in the read image data, the abnormality detector 520 stores the read image data including the abnormality in the storage 505 as sample image data 550A to 550M.

In one aspect, the storage 505 is achieved by the auxiliary storage device 210 of the image forming device 100. In another aspect, the storage 505 may be achieved by an electrically rewritable non-volatile memory disposed in the controller 117, 150 of the image forming device 100 or the image inspection device 102. In still another aspect, the storage 505 may be achieved by the auxiliary storage device 415 or the storage medium 418 of the client terminal 155 or another server device.

As described in detail later, the storage 505 stores the sample image data 550A to 550M together with feature parameters 545A to 545M corresponding thereto, respectively. Note that in the example of FIG. 5, the number of pieces of the sample image data 550A to 550M stored in the storage 505 is 13, and the number of the feature parameters 545A to 545M stored in the storage 505 is 13, but these numbers are not limited.

The feature parameter acquisitor 522 acquires at least one feature parameter which is information representing a feature of a print job. As the feature parameter, a parameter representing a feature of the original image data in the print job may be used, or setting information included in the print job may be used. In the first embodiment, as an example, a character area ratio and a figure area ratio in a bitmap format image generated on the basis of the original image data of the print job are used as feature parameters. A case where paper setting information in the print job is used as a feature parameter will be described in fourth and fifth embodiments.

In order to acquire a character area ratio and a figure area ratio in a bitmap image based on original image data, the feature parameter acquisitor 522 acquires attribute information on the basis of the original image data described in PDL. The attribute information is information representing an attribute of each pixel of a bitmap format image generated on the basis of the original image data, for example, information representing which of a figure, a character, and the like in the bitmap format image the pixel constitutes.

For example, on the basis of the data described in PDL, the feature parameter acquisitor 522 acquires an attribute of each pixel in an area where a character such as kana, an alphabet, a symbol, or a number is formed as a character attribute, and acquires an attribute of each pixel in an area where a figure such as a line, a polygon, or a circle is formed as a figure attribute. The feature parameter acquisitor 522 may acquire the attribute information for a pixel having a character attribute, and for each attribute such as a number attribute, an alphabet attribute, or a symbol attribute. In a case where the feature parameter acquisitor 522 has an instruction to generate a barcode in the data described in PDL, the feature parameter acquisitor 522 acquires an attribute of each pixel in an area where the barcode is formed according to the instruction as a barcode attribute. The feature parameter acquisitor 522 acquires an attribute of each pixel in an area where a photograph is formed on the basis of a file such as joint photographic experts group (JPEG) as a photograph attribute. The feature parameter acquisitor 522 can acquire an attribute of a pixel that does not have any attribute as a background attribute.

On the basis of an attribute of each pixel of such a bitmap image, the bitmap image is divided into a plurality of image areas having different attributes from each other. The feature parameter acquisitor 522 acquires the ratio of each image area in the bitmap image as a feature parameter. For example, in a case where a bitmap image generated on the basis of the original image data is divided into a figure area and a character area, the feature parameter acquisitor 522 acquires a figure area ratio R1 and a character area ratio R2 in the bitmap image as feature parameters. In a case where the bitmap image based on the original image data is divided into a plurality of image areas such as an alphabet area, a symbol area, a number area, a barcode area, a photograph area, and a background area, the feature parameter acquisitor 522 may acquire the ratio of each of the image areas in the bitmap image as a feature parameter.

The feature parameter acquisitor 522 may acquire information indicating in which attribute image area, an abnormal portion in the read image data is included on the basis of a detection result by the abnormality detector 520. For example, the feature parameter acquisitor 522 acquires information indicating whether the abnormal portion in the read image data is included in a figure area or a character area. Details thereof will be described in a second embodiment.

The feature parameter acquisitor 522 stores each of pieces of the sample image data 550A, 550B, . . . 550M in the storage 505 together with at least one feature parameter acquired in a print job corresponding to each of the sample images. As a result, a database 555 including a plurality of pieces of sample image data each including an abnormal portion and a plurality of feature parameters associated with the pieces of sample image data, respectively, is generated.

(Abnormality Detection Level Setting Process)

Next, a process of setting an abnormality detection level in a print job to be executed on the basis of user's evaluation for a sample image will be described. The abnormality detection level setting process is executed by the feature parameter acquisitor 522, the searcher 525, and the detection level setter 530.

When the client terminal 155 transmits a print job to be executed to the image forming device 100, the print job is received by the controller 150 of the image inspection device 102. The feature parameter acquisitor 522 of the image inspection device 102 acquires at least one feature parameter representing a feature of the received print job. In a case where the print job includes a plurality of pieces of original image data, the feature parameter acquisitor 522 can acquire a feature parameter of each of the pieces of original image data.

The searcher 525 searches for a feature parameter that is similar or identical to the feature parameter of the print job to be executed from among the feature parameters 545A, 545B, . . . 545M in the database 555. For example, the searcher 525 searches the database 555 for a feature parameter within a threshold range for the feature parameter based on the print job to be executed. The searcher 525 registers the identification number of a sample image (hereinafter, also referred to as sample number) associated with the found feature parameter in a suitable sample list 565 as a search result. In the example of FIG. 5, the suitable sample list 565 is stored in a storage area of the RAM of the controller 150. Note that in a case where the feature parameter that is identical or similar to the feature parameter of the print job to be executed is not stored in the database 555, the identification number is not registered in the suitable sample list 565.

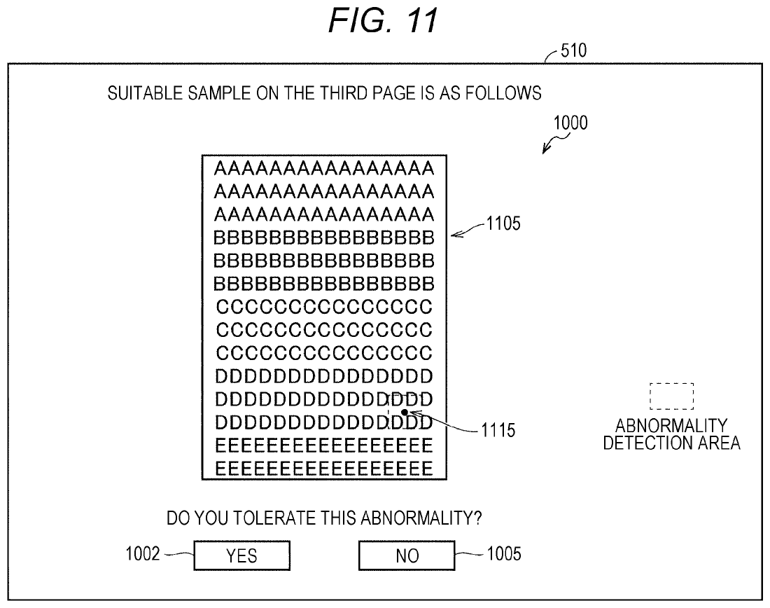

The display 510 displays sample image data corresponding to the identification number registered in the suitable sample list 565 among the sample image data 550A to 550M in the database 555 as a suitable sample image according to an instruction from the searcher 525. The display 510 may be achieved by either the monitor 134 of the operation panel 130 or the monitor 440 of the client terminal 155. Note that in a case where a plurality of identification numbers is registered in the suitable sample list 565, the display 510 may display sample image data associated with a feature parameter closest to the feature parameter of the print job to be executed among feature parameters associated with sample images corresponding to the stored identification numbers. Specific examples of the sample image displayed on the display 510 will be described later with reference to FIGS. 10 and 11.

The acceptor 515 accepts user's evaluation for an abnormality included in the sample image data displayed on the display 510, that is, whether or not the displayed abnormality is tolerated by the user. The acceptor 515 may be achieved by either the button 132 of the client terminal 155 or the keyboard 422 of the client terminal 155.

The detection level setter 530 sets an abnormality detection level in the abnormality detector 520 on the basis of the accepted user's evaluation. For example, in a case where the abnormality displayed on the monitor 134, 440 is tolerated by a user, the detection level setter 530 may set the abnormality detection level to a lower sensitivity than the currently set detection level. That is, the detection level setter 530 may set a threshold of a density difference or the like used for detecting an abnormality when comparing a read image with a correct image to be larger than the currently set threshold.

On the other hand, in a case where the abnormality displayed on the monitor 134, 440 is not tolerated by a user, the detection level setter 530 may maintain the abnormality detection level or may set the abnormality detection level to a higher sensitivity than the currently set detection level. That is, in a case where the detection level setter 530 sets the abnormality detection level to a higher sensitivity, the detection level setter 530 may set the threshold used for detecting an abnormality to be smaller than the currently set threshold.

Note that in a case where the print job includes a plurality of pages, the detection level setter 530 can set the abnormality detection level for each page selected by a user. More specifically, the detection level setter 530 adds the abnormality detection level set for each page to setting information for each page of a print job to be executed. In the job, the abnormality detector 520 detects an abnormality included in a printed image formed on paper using the abnormality detection level set for each page.

In the above database generation process and abnormality detection level setting process, the functions of the feature parameter acquisitor 522, the searcher 525, and the detection level setter 530 may be achieved by an operation of the CPU of the controller 117 according to a program stored in the ROM 310. Alternatively, the above functions may be achieved by a so-called cloud service in which at least one server executes all or some of processes of a program thereof.

A specific example of a search process executed by the searcher 525 on the basis of the database 555 will be described with reference to FIG. 6. FIG. 6 is a diagram illustrating an example of a figure area ratio and a character area ratio in a table format for a selected page of a print job to be executed and a plurality of sample images.

In FIG. 6, the figure area ratio and the character area ratio are illustrated as feature parameters for each of sample images of sample numbers 1 to 8 of each of jobs A, B, and C. These values of the figure area ratio and the character area ratio are stored in the database 555 together with the sample images corresponding thereto, respectively.

Furthermore, FIG. 6 also illustrates a figure area ratio and a character area ratio for a selected page. A user selects one of a plurality of pages included in a job to be executed as the selected page.

The searcher 525 searches the database for a figure area ratio and a character area ratio within threshold ranges with respect to the figure area ratio and the character area ratio of the selected page of the job to be executed, respectively, as feature parameters that are similar to a feature of the print job to be executed.

In the example of FIG. 6, the figure area ratio of the page of the job to be executed is “50%”, and the character area ratio of the job to be executed is “30%”. Therefore, for example, each of the above threshold ranges is defined as a range within ±10% of the figure area ratio or the character area ratio of the page of the job to be executed. Note that the above threshold range is an example and is not limited.

Specifically, as illustrated in FIG. 6, in a case where a first condition that the figure area ratio of a sample image is within a range of 45% to 55% is satisfied, and in a case where a second condition that the character area ratio of the sample image is within a range of 27% to 33% is satisfied, the sample image is a search target. In the table illustrated in FIG. 6, a cell satisfying the first condition or the second condition is hatched.

Therefore, the searcher 525 registers the sample number 5 of the job C, which is an identification display of a sample image satisfying the first condition and the second condition, in the suitable sample list 565 as a search result. The CPU of the controller 117 of the image inspection device 102 displays the sample image of sample number 5 of the job C on the display 510 as a suitable sample image. An abnormality detection level is set on the basis of user's evaluation for the suitable sample image displayed on the display 510.

In another aspect, in a case where the identification numbers of a plurality of suitable sample images are registered in the suitable sample list 565, the searcher 525 may acquire, from a figure area ratio and a character area ratio of the image of the selected page and a figure area ratio and a character area ratio of each of the sample image, an evaluation value indicating closeness between these images.

For example, the searcher 525 acquires the total of a difference between the figure area ratio of the image of the selected page and the figure area ratio of a sample image and a difference between the character area ratio of the image of the selected page and the character area ratio of the sample image as an evaluation value. The searcher 525 determines an image closest to the image of the selected page, that is, an image having the smallest evaluation value among the plurality of suitable sample images whose identification numbers are registered in the suitable sample list 565 as a first suitable sample image.

At this time, the CPU of the controller 117 of the image inspection device 102 may display the first suitable sample image on the display 510 as a sample image having a feature parameter closest to a feature parameter of a print job to be executed.

[Procedure for Setting Abnormality Detection Level]

Hereinafter, a procedure for setting an abnormality detection level will be described with reference to FIGS. 7 to 11. FIG. 7 is a flowchart illustrating an example of a procedure for setting an image abnormality detection level in the image forming system 170 of the first embodiment. In an aspect, the process illustrated in FIG. 7 is implemented by execution of a process program stored in the ROM by the CPU of the controller 150 disposed in the image inspection device 102.

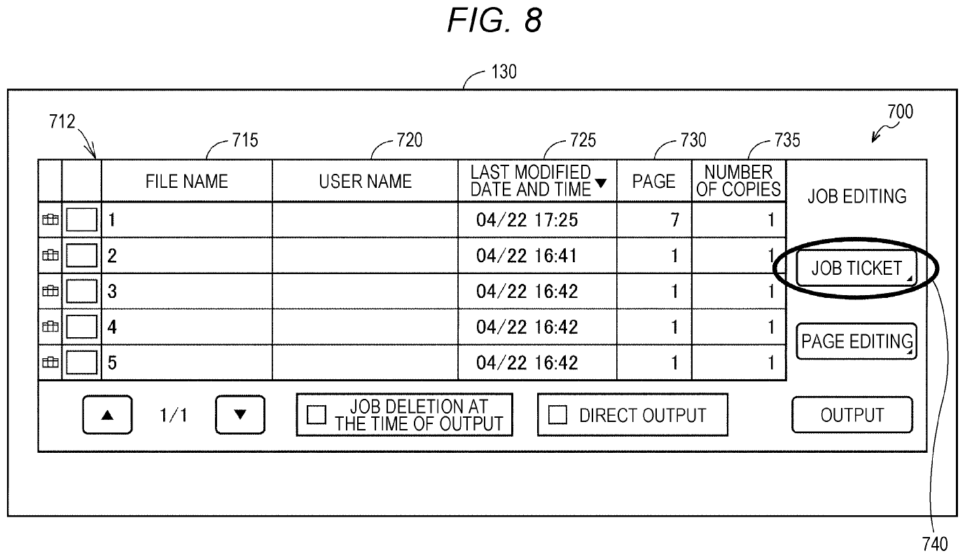

In step S605, the CPU accepts selection of a print job on the basis of a user operation via the operation panel 130. An example of a display screen displayed on the operation panel 130 at this time will be described with reference to FIG. 8.

FIG. 8 is a diagram illustrating an example of a job list screen 700 displayed on the operation panel 130 for accepting selection of a print job from a user. The job list screen 700 includes a job list 712 that displays a list of print jobs stored in the auxiliary storage device 210 and a job ticket button 740.

In the example of FIG. 8, the job list 712 indicates a file name 715 of a corresponding print job, a user name 720, a last modified date 725, the number of pages 730, and the number of copies 735. A user selects a print job by selecting one of the file names 715 listed in the job list 712.

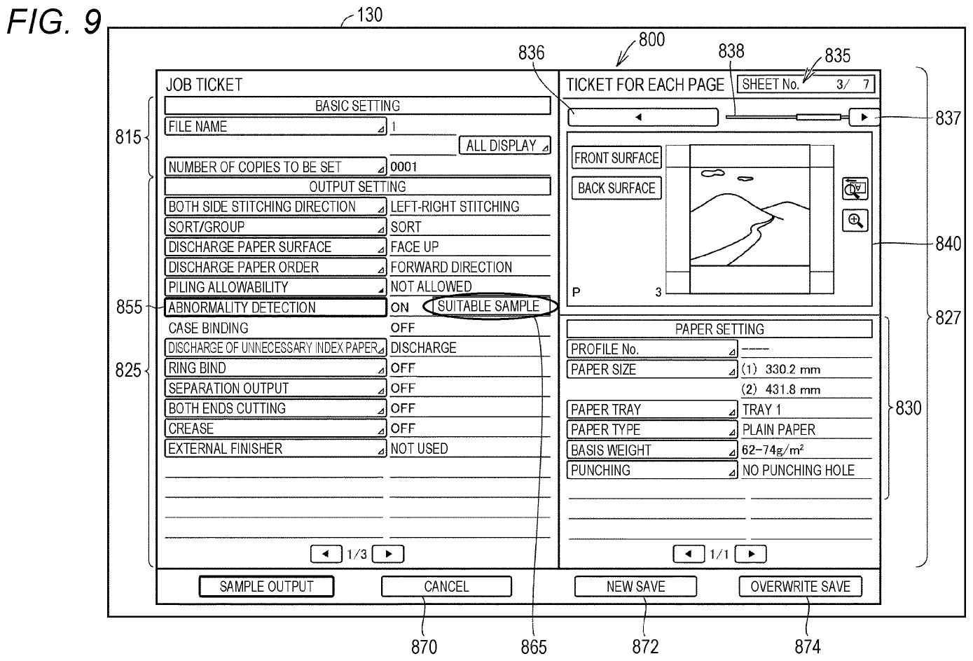

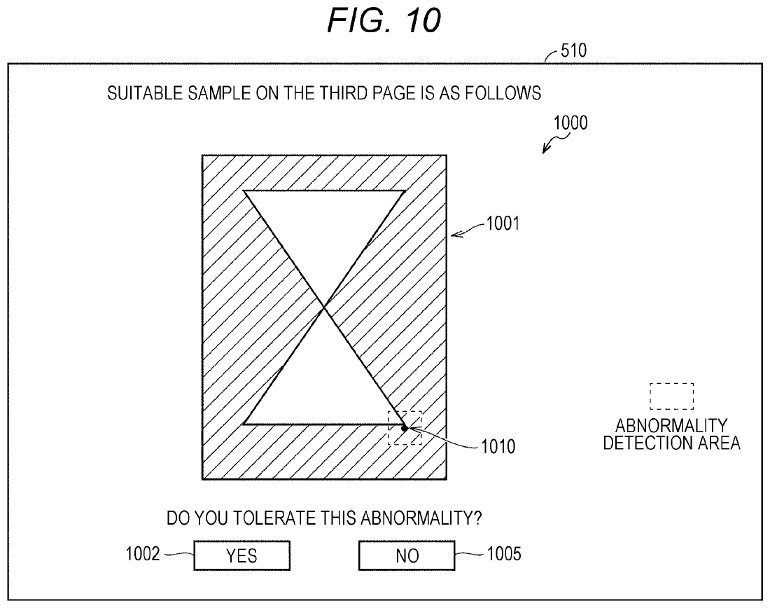

The job ticket button 740 is a button for switching the screen displayed on the operation panel 130 to a job ticket editing screen 800 of FIG. 9 for editing various types of setting information of the selected print job. The CPU switches the screen on the operation panel 130 to the job ticket editing screen 800 of the selected print job on the basis of operation of the job ticket button 740 by a user.

With reference to FIG. 7 again, in step S610, the CPU accepts selection of a page in the print job selected in step S605 on the basis of a user operation on the job ticket editing screen 800 on the operation panel 130. At this time, the CPU may accept selection of all pages of the print job, or may accept selection of a plurality of representative pages. In this way, in a case where the CPU accepts selection of all or representative pages, the CPU executes processes in the following steps S620 to S680 for each selected page.

In a subsequent step S615, the CPU accepts an instruction to search for a suitable sample image for the selected page on the basis of a user operation via the operation panel 130.

Hereinafter, an example of the job ticket editing screen 800 displayed on the operation panel 130 in step S610, 615 will be described with reference to FIG. 9.

FIG. 9 is a diagram illustrating an example of the job ticket editing screen 800 displayed on the operation panel 130 in step S610, 615 in order to accept user's page selection and an instruction to search for a suitable sample image.

The job ticket editing screen 800 includes a page-based ticket editing screen 827, a basic setting button group 815, an output setting button group 825, a cancel button 870, a new save button 872, and an overwrite save button 874.

The basic setting button group 815 and the output setting button group 825 are operated by a user in order to set setting information common to all pages in the selected print job. On the other hand, the page-based ticket editing screen 827 includes a button operated by a user in order to set setting information for each selected page.

More specifically, the page-based ticket editing screen 827 includes a page number display window 835, a page feed button 836, 837, a page feed bar 838, a window 840, and a paper setting button group 830.

The page feed button 836, 837 and the page feed bar 838 are operated by a user in order to select a page in the print job selected in step S605 (step S610).

The page number display window 835 displays the page number selected in step S610 in the print job selected in step S605. The page number is a number assigned to the original image data in the execution job. In the example of FIG. 9, the selected page number is 3.

The window 840 previews a bitmap image based on the original image data of a page selected via the page feed button 836, 837 or the page feed bar 838. A user can select a page for which an abnormality detection level is set using a sample image while viewing the bitmap image that is switched using the page feed button 836, 837 or the page feed bar 838.

The paper setting button group 830 is operated by a user in order to set setting information regarding paper, such as the size, paper type, or basis weight of paper used for the selected page.

The basic setting button group 815 is operated by a user in order to set the file name of a print job and the number of copies to be set.

The output setting button group 825 is operated by a user in order to set sorting, paper discharge order, presence or absence of execution of an abnormality detection process, and the like. The output setting button group 825 further includes an abnormality detection button 855 and a suitable sample button 865.

Specifically, the abnormality detection button 855 accepts user's setting as to whether or not the image inspection device 102 executes an abnormality detection process of a printed image.

The suitable sample button 865 accepts an instruction to search for a suitable sample image to set an abnormality detection level for the selected page in a case where a user has set the suitable sample button 865 so as to perform an abnormality detection process (step S615). Note that a default abnormality detection level is set for a page that does not execute a process of searching for a suitable sample image.

The cancel button 870 is operated by a user in order to cancel setting based on the job ticket editing screen 800. The new save button 872 is operated by a user in order to newly save the setting as new setting information in the storage 505 such as the auxiliary storage device 210. The overwrite save button 874 is operated by a user in order to overwrite and save the setting. In a case where a user sets a detection level based on the suitable sample image, the user can save the set detection level in association with the print job by operating the new save button 872 or the overwrite save button 874.

Hereinafter, with reference to FIG. 7 again, a process executed by the CPU when a user operates the suitable sample button 865 (step S615) will be described.

In step S620, the CPU acquires a figure area ratio R1 and a character area ratio R2 in a selected page of a print job to be executed. As described with reference to FIG. 5, the CPU acquires these ratios, for example, by analyzing the contents of the original image data described in PDL. Note that as a result of such analysis, in a case where the figure area ratio R1 and the character area ratio R2 are already included in the print job as feature parameters, the CPU acquires the feature parameters from the print job.

In a subsequent step S625, the CPU determines whether or not there is a sample image including an abnormal portion stored in the storage 505 (hereinafter, referred to as “past sample image”). If there is a past sample image (YES in step S625), the CPU causes the process to proceed to step S635. On the other hand, if there is no past sample image (NO in step S625), the CPU displays that there is no suitable sample image on the operation panel 130 in step S670, and then ends a series of processes.

In step S635, the CPU acquires a figure area ratio r1 and a character area ratio r2 for each of M sample images stored in the database 555 of the storage 505. These area ratios r1 and r2 are stored in the database 555 as feature parameters in association with each sample image.

In a subsequent step S640, the CPU initializes the count number N for counting a sample image to be processed to 1.

Ina subsequent step S645, the CPU determines, for a sample image to be processed, whether or not a difference between the figure area ratio R1 of the bitmap image based on the original image data and the figure area ratio r1 of a sample image and a difference between the character area ratio R2 of the bitmap image based on the original image data and the character area ratio r2 of the sample image are within threshold ranges, respectively. If both of these differences are within the threshold ranges, respectively (YES in step S645), the CPU registers the identification number of the sample image in the suitable sample list 565 in step S647, and then causes the process to proceed to step S650. On the other hand, if at least one of these differences is not within the threshold range (NO in step S645), the CPU causes the process to proceed to step S650.

In step S650, the CPU counts up the count number N.

In a subsequent step S655, the CPU determines whether or not the count number N is equal to or less than M, which is the number of sample images stored in the storage 505. If the count number N is M or less (YES in step S655), the CPU returns the process to step S645. Thereafter, the CPU repeats the process of step S645 until the count number N becomes larger than M, that is, until the processes for all the sample images are completed. If the count number N is larger than M (NO in step S655), the CPU causes the process to proceed to step S660.

In a subsequent step S660, the CPU determines whether or not the identification number of A sample image is registered in the suitable sample list 565. If the identification number is registered in the suitable sample list 565 (YES in S660), the CPU causes the process to proceed to step S665. On the other hand, if the identification number is not registered in the suitable sample list 565 (NO in S660), the CPU displays that there is no suitable sample image on the operation panel 130 in step S670, and then ends a series of processes.

In step S665, the CPU displays a sample image corresponding to the identification number stored in the suitable sample list 565 on the display 510.

In a subsequent step S675, the CPU accepts user's evaluation for the suitable sample image displayed on the display 510 via the acceptor 515.

In a subsequent step S680, the CPU sets an abnormality detection level for the selected page on the basis of the user's evaluation accepted in step S675. More specifically, the CPU adds the set value of the set abnormality detection level to setting information of a selected page in a print job to be executed. Note that in step S615, the abnormality detection level set by default for a print job is applied to an abnormality detection level of a page other than the selected page. In another aspect, the abnormality detection level for a page other than the selected page may be determined on the basis of the abnormality detection level for the selected page. For example, the abnormality detection level of a page other than the selected page may be defined as an average value of the abnormality detection levels of the selected pages. After step S675, the CPU ends a series of processes.

Hereinafter, an example of the sample image displayed in step S665 will be described with reference to FIGS. 10 and 11.

FIGS. 10 and 11 are each a diagram illustrating an example of the suitable sample image display screen 1000 displayed on the display 510 in order to inquire a user whether or not to tolerate an abnormality included in a suitable sample image.

In FIGS. 10 and 11, the suitable sample image display screen 1000 includes a sample image 1001, 1105, a tolerant button 1002, and a non-tolerant button 1005. The sample image 1001 of FIG. 10 is an image including only “figures” and includes an abnormal portion 1010. The sample image 1105 of FIG. 11 is an image including only “characters” and includes an abnormal portion 1115.

The tolerant button 1002 is operated by a user when the user tolerates the abnormal portion 1010 or 1115.

The non-tolerant button 1005 is operated by a user when the user does not tolerate the abnormal portion 1010 or 1115. As a result, the CPU accepts user's evaluation for the suitable sample image (step S675) and sets an abnormality detection level on the basis of this user's evaluation (step S680).

As described above, whether or not a user tolerates an abnormality included in an image printed on paper depends on a feature of the printed image. For example, the user's tolerance may be different between a case where an image printed in a job to be executed includes only “figures” and a case where an image printed in a job to be executed includes only “characters” even if the abnormalities are at the same detection level. For example, the abnormal portion 1010 included in the sample image 1001 including only “figures” may be tolerated by a user, while the abnormal portion 1115 included in the sample image 1105 including only “characters” is unlikely to be tolerated by the user.

Therefore, for example, in a case where the bitmap data based on the original image data of a job to be executed includes only “figures”, the searcher 525 searches for sample image data associated with a feature parameter that is identical or similar to the feature parameter representing a feature of the original image data of the job. More specifically, the searcher 525 searches the database 555 for suitable sample image data in which a figure area ratio and a character area ratio are identical or similar to those in the bitmap image based on the original image data. In the example of FIG. 10, the sample image 1001 including only “figures” corresponds to the suitable sample image. The CPU of the image inspection device 102 displays the sample image 1001 including only “figures” on the display 510 as the suitable sample image.

On the other hand, for example, in a case where the bitmap data based on the original image data of a job to be executed includes only “characters”, similarly, the sample image 1115 including only “characters” of FIG. 11 corresponds to the suitable sample image. In this case, the CPU of the image inspection device 102 displays the sample image 1115 including only “characters” on the display 510 as the suitable sample image.

Hereinafter, a modification of the above processing procedure will be described. Unlike the example of FIG. 7, the CPU may automatically execute steps S620 to S680 for each of suitable sample images corresponding to the first page and the last page of a print job instead of the processes in step S610, S615. The CPU may further automatically execute steps S620 to S680 for each of a page having the largest figure area ratio and a page having the largest character area ratio in a print job. As a result, a detection level can be set using the suitable sample image while user's trouble for selecting a page is saved.

[Effect of First Embodiment]

In the image forming system 170 according to the first embodiment, the searcher 525 searches the database 555 for a sample image having a feature parameter that is identical or similar to a feature parameter representing a feature of the original image data in a print job to be executed. The sample image is stored in the database 555 in association with the feature parameter. More specifically, in a case where a sample image is divided into a plurality of image areas having different attributes from each other, the ratio of each of the image areas is used as the feature parameter. As a result, a sample image having a feature close to the feature of the original image data of the print job to be executed can be displayed on the display 510. Therefore, an abnormality detection level can be set so as to reflect user's tolerance for an abnormality that can be generated in the printed image of the print job to be executed as much as possible. As a result, the accuracy of the abnormality detection process is improved.

In a case where the above method is not used, it is necessary to display a plurality of sample images stored in the storage 505 on the display, and it is necessary for a user to select an appropriate sample image according to original image data of a print job to be executed. The image forming system 170 of the first embodiment can save user's trouble for selecting an appropriate sample image in this way.

### Second Embodiment

An image forming system 170 of a second embodiment is different from the image forming system 170 of the first embodiment described above in that the CPU of the image inspection device 102 searches for a sample image having an abnormality in an image area (area having the same attribute, such as a character area or a figure area) designated by a user. The other points of the image forming system 170 in the second embodiment are similar to those in the first embodiment. Therefore, the same or corresponding parts are designated by the same reference numeral, and description thereof will not be repeated.

Specifically, information indicating in which attribute image area, an abnormality has been detected in a sample image is stored in the database 555 together with a feature parameter representing the ratio of each image area. The CPU of the image inspection device 102 accepts designation of an image area in which an abnormality has been detected among the plurality of image areas from a user. Then, the CPU searches for a sample image satisfying both a condition that each of the ratios of the plurality of image areas divided on the basis of an attribute is identical or similar to the case of the original image data and a condition that an abnormality has been detected in the image area designated by a user.

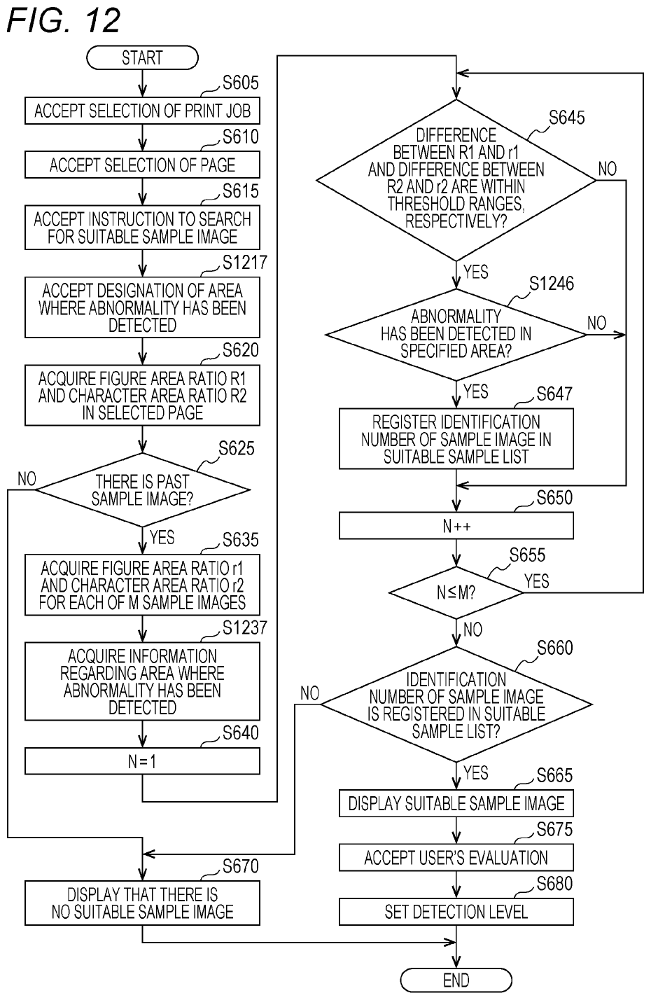

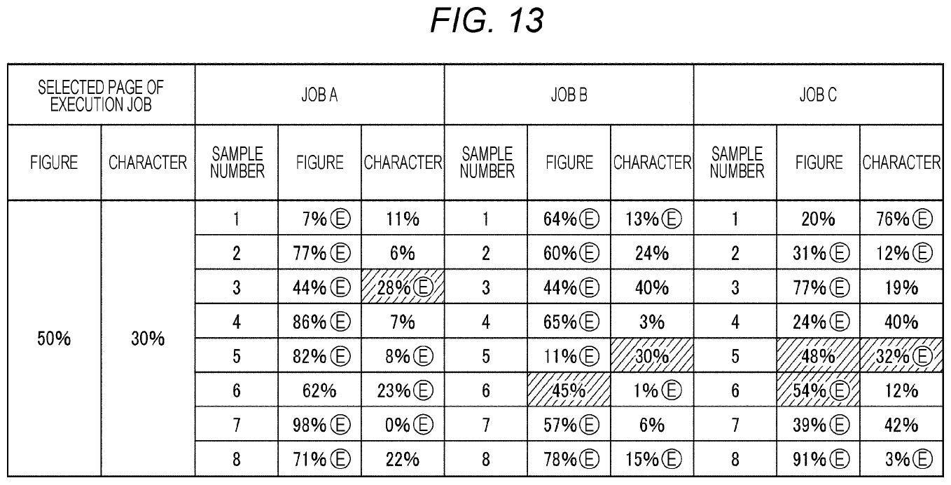

Hereinafter, a process executed by the CPU of the image inspection device 102 in the second embodiment will be described in detail with reference to FIGS. 12 and 13.

FIG. 12 is a flowchart illustrating an example of a procedure for setting an image abnormality detection level in the image forming system 170 of the second embodiment. In an aspect, the process illustrated in FIG. 12 is implemented by execution of a process program stored in the ROM by the CPU of the image inspection device 102. Note that the same process as that illustrated in the flowchart of FIG. 7 is designated by the same step number, and therefore description of the process will not be repeated.

First, the CPU executes processes from step S605 to step S615 of FIG. 7. In step S615, the CPU accepts an instruction to search for a suitable sample image from a user.

In a subsequent step S1217, the CPU accepts designation of an area where an abnormality has been detected from a user. For example, after the suitable sample button 865 of FIG. 9 is operated by a user, the CPU displays a screen that inquires the user whether to search for an sample image in which the area where an abnormality has been detected is a figure area or an sample image in which the area where an abnormality has been detected is a character area on the operation panel 130. In another aspect, the CPU may display, on the operation panel 130, a screen that inquires a user whether to search for a sample image in which the area where an abnormality has been detected is a background area, a sample image in which the area where an abnormality has been detected is a photograph area, or a sample image in which the area where an abnormality has been detected is a barcode area, for example. By displaying such an inquiry screen on the operation panel 130, the CPU accepts the designation of the area where an abnormality has been detected from the user.

Next, the CPU executes processes from step S620 to step S635 of FIG. 7. In step S635, the CPU acquires a figure area ratio r1 and a character area ratio r2 from the database 555 for each of M sample images.

In a subsequent step S1237, the CPU acquires information regarding an area where an abnormality has been detected. More specifically, in a case where a bitmap format image based on original image data is divided into a plurality of image areas according to an attribute, the CPU acquires information indicating in which attribute image area, an abnormal portion has been detected from the database 555. As an example, the CPU acquires information indicating whether the image area is a figure area or a character area.

Next, the CPU executes processes of steps S640 and S645 of FIG. 7. In step S645, the CPU determines, for a sample image to be processed, whether or not a difference between the figure area ratio R1 of the bitmap format image based on the original image data and the figure area ratio r1 of a sample image and a difference between the character area ratio R2 of the bitmap format image based on the original image data and the character area ratio r2 of the sample image are within threshold ranges, respectively. If the CPU determines that it is YES (that is, within a threshold range) in step S645, the CPU causes the process to proceed to step S1246.

In step S1246, the CPU determines whether or not an abnormality has been detected in an area designated by a user in a sample image. If an abnormality has been detected in the designated area (YES in step S1246), the CPU registers the identification number of the sample image in the suitable sample list 565 in step S647, and then causes the process to proceed to step S650. On the other hand, if no abnormality has been detected in the designated area (NO in step S1246), the CPU causes the process to proceed to step S650.

Subsequent processes in steps S650 to S680 are similar to those of FIG. 7, and therefore description thereof will not be repeated.

Hereinafter, a specific example of the determination process executed in S1246 will be described with reference to FIG. 13. FIG. 13 is a diagram clearly illustrating an area where an abnormality has been further detected in FIG. 6.

In the table illustrated in FIG. 13, a cell marked with “E” indicates that an abnormality has been detected in an area corresponding to the cell. For example, in the sample image corresponding to the sample number “5” of the job C, it is indicated that an abnormality has been detected in a character area while no abnormality has been detected in a figure area.

As described with reference to FIG. 5, the sample image of the sample number 5 of the job C satisfies a condition that a character area ratio and a figure area ratio of the sample image are within threshold ranges based on a figure area ratio and a character area ratio of a page of a job to be executed, respectively (YES in step S645).

Furthermore, in step S1217 of FIG. 12, for example, in a case where the character area is an area designated by a user, the above sample image satisfies a condition that an abnormality has been detected in an area designated by a user (YES in step S1246). Therefore, the searcher 525 registers the sample number 5 of the job C in the suitable sample list 565 as a search result (step S647).

[Effect of Second Embodiment]

In the image forming system 170 according to the second embodiment, the CPU of the image inspection device 102 accepts designation of an area where an abnormality has been detected among a plurality of areas according to attribute information from a user. The searcher 525 searches for the identification number of a suitable sample image on the basis of an attribute of the area designated by the user in addition to a feature parameter indicating each of the ratios of a plurality of areas in a bitmap format image based on original image data.

The CPU displays the found suitable sample image on the display 510. This makes it possible to reflect user's tolerance for an abnormality, which may change depending on an attribute of an area where an abnormality has been detected, in an abnormality detection level.

### Third Embodiment

An image forming system 170 of a third embodiment considers a case where the number of pages of original image data included in a print job is large. Specifically, the CPU of the image inspection device 102 classifies pages of an execution job according to in which numerical ranges, a figure area ratio and a character area ratio of each page are included, respectively. The classification results are listed on the operation panel 130. The searcher 525 searches the database 555 for suitable sample image data corresponding to a numerical range selected from the list display by a user. As a result, the user does not need to consider whether to search for a suitable sample image on all the pages. The image forming system 170 of the third embodiment is different from the image forming systems 170 of the above-described first and second embodiments in the above points.

Note that the hardware configuration of the image forming system 170 of the third embodiment is similar to the hardware configuration in the case of the first embodiment illustrated in FIGS. 1 to 4. In addition, the functional configuration in the image forming system 170 of the third embodiment is basically similar to the functional configuration illustrated in FIG. 5. Therefore, the same or corresponding parts are designated by the same reference numeral, and description thereof will not be repeated.

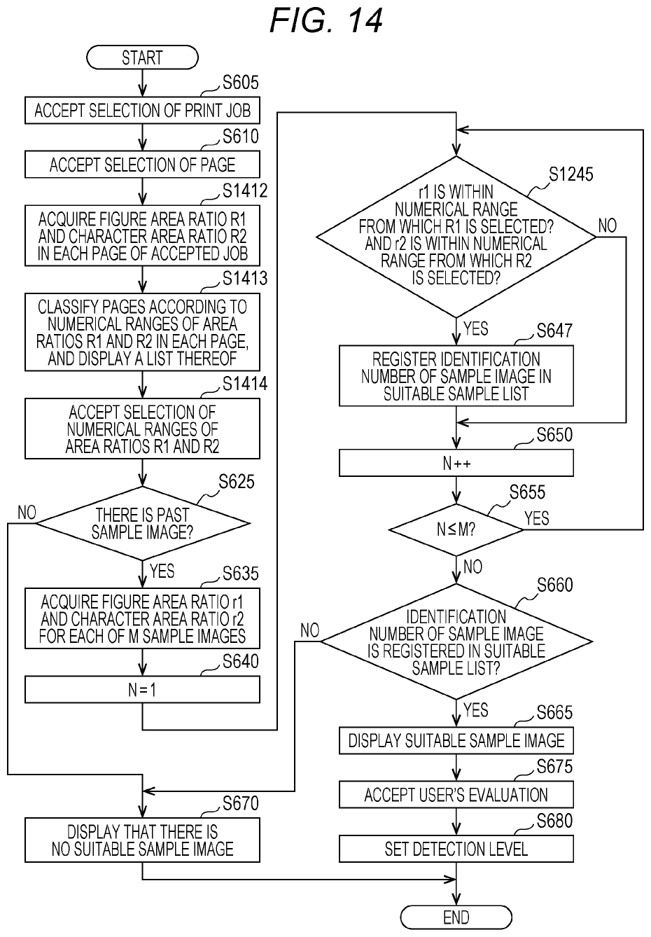

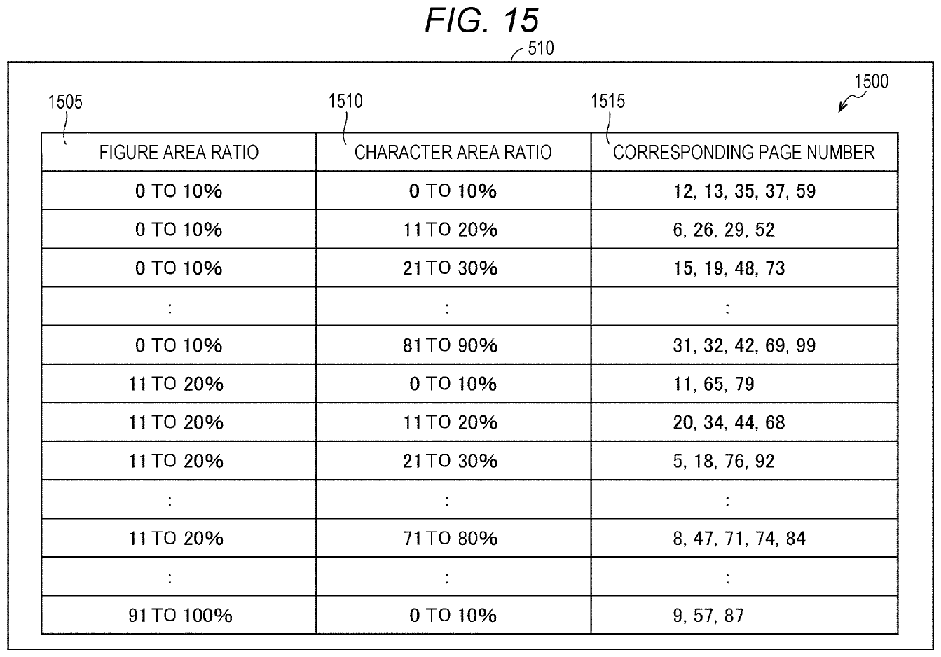

Hereinafter, a process executed by the CPU of the image inspection device 102 in the third embodiment will be described with reference to FIGS. 14 and 15.

FIG. 14 is a flowchart illustrating an example of a procedure for setting an image abnormality detection level in the image forming system 170 of the third embodiment. In an aspect, the process illustrated in FIG. 14 is implemented by execution of a process program stored in the ROM by the CPU of the image inspection device 102. In addition, the same process as that described above is designated by the same step number. Therefore, description of the same process will not be repeated.

First, the CPU executes processes of steps S605 and S610 of FIG. 7. In step S605, the CPU accepts selection of a print job from a user. In step S610, the CPU accepts an instruction to search for a suitable sample image from the user.

In a subsequent step S1412, the CPU acquires the figure area ratio R1 and the character area ratio R2 in each page of the job accepted in step S605. As described with reference to FIG. 5, the CPU acquires the ratios of the image areas in the bitmap format image based on the original image data, for example, by analyzing the contents of the original image data described in PDL. Note that as a result of such analysis, in a case where the figure area ratio R1 and the character area ratio R2 are already included in the print job as feature parameters, the CPU acquires the feature parameters from the print job.

In a subsequent step S1413, the CPU classifies pages according to in which numerical range, the figure area ratio R1 and the character area ratio R2 in each page are included, and displays a list of page numbers included in each numerical range on the operation panel 130.

In a subsequent step S1414, the CPU accepts selection of the numerical ranges of the figure area ratio R1 and the character area ratio R2.

Hereinafter, an example of the display screen displayed on the operation panel 130 in steps S1413 and 1414 will be described with reference to FIG. 15.

FIG. 15 is a diagram illustrating an example of a screen displaying a list of results of classifying pages of an execution job according to an image area ratio and a character area ratio included in a bitmap format image based on original image data.

A list display screen 1500 displays the page number 1515 of a page corresponding to each of numerical ranges of a figure area ratio 1505 and a character area ratio 1510 (step S1413). The CPU accepts selection of numerical ranges represented by the figure area ratio 1505 and the character area ratio 1510 or a page number included in the numerical ranges from a user (step S1414).

Hereinafter, with reference to FIG. 14 again, a process executed by the CPU when a numerical range is selected by a user on the list display screen 1500 will be described.

The CPU executes processes from step S625 to step S640 of FIG. 7. Specifically, in step S635, the CPU acquires the figure area ratio r1 and the character area ratio r2 for each of M sample images stored in the database 555 of the storage 505. In step S640, the CPU initializes the count number N for counting a sample image to be processed to 1.

In a subsequent step S1245, the CPU determines, whether or not both a condition that the figure area ratio r1 of a sample image is within a numerical range from which the figure area ratio R1 of the bitmap format image based on the original image data is selected, and a condition that the character area ratio r2 of the sample image is within a numerical range from which the character area ratio R2 of the bitmap format image based on the original image data is selected are satisfied. If the above both conditions are satisfied (YES in step S1245), the CPU registers the identification number of the sample image in the suitable sample list 565 in step S647, and then causes the process to proceed to step S650. On the other hand, if at least one of the above conditions is not satisfied (NO in step S1245), the CPU causes the process to proceed to step S650.

Thereafter, the CPU counts up the count number N in step S650 of FIG. 7. In a subsequent step S655, the CPU repeats the process in step S645 (and step S1246) until the count number N becomes larger than M. If the count number N is larger than M (NO in step S655), the CPU causes the process to proceed to step S660.

Thereafter, the CPU executes processes in steps S660 to S680 of FIG. 7, and then ends a series of processes.

Note that in the example of FIG. 15, about 3 to 5 pages in the print job relatively evenly correspond to each of the numerical ranges related to the figure area ratio 1505 and the character area ratio 1510. However, in a normal print job, most pages of the print job often correspond intensively to a part of each of the numerical ranges of the figure area ratio 1505 and the character area ratio 1510. In such a case, a user can set an abnormality detection level for the most pages of the print job by inputting evaluation for a suitable sample images displayed for a part of each of the numerical ranges.

[Effect of Third Embodiment]

In an image forming system 170 according to a third embodiment, the CPU of the image inspection device 102 classifies pages of an execution job according to in which numerical ranges, a figure area ratio and a character area ratio of each page are included, respectively. The classification results are listed on the operation panel 130. The searcher 525 searches the database 555 for a suitable sample image corresponding to a numerical range selected from the list display by a user or the page number, and displays the suitable sample image on the operation panel 130. The user inputs evaluation for the displayed suitable sample image.

As a result, even in a case where the number of pages of original image data included in a print job is large, a user does not need to consider whether to search for a suitable sample image on all the pages. In addition, in a case where the selected numerical range corresponds to a plurality of pages of a print job, a detection level can be set collectively using the same sample image for these pages. Therefore, a user can reduce a trouble for setting an abnormality detection level.

### Fourth Embodiment

An image forming system 170 of a fourth embodiment is different from the image forming systems 170 of the first to third embodiments described above in that the CPU of the image inspection device 102 uses setting information of paper as a recording medium in a print job to be executed as a feature parameter.

Note that the hardware configuration of the image forming system 170 of the fourth embodiment is similar to the hardware configuration in the case of the first embodiment. In addition, the functional configuration of the image forming system 170 of the fourth embodiment is basically similar to the functional configuration illustrated in FIG. 5. Therefore, the same or corresponding parts are designated by the same reference numeral, and description thereof will not be repeated.

In general, whether or not an abnormality included in a printed image on paper is tolerated by a user may depend on the basis weight, size, paper type, gloss, and the like of the paper.

For example, in a case where the basis weight of paper is small, that is, in a case where the paper is thin, an image formed on a lower surface of the paper may cause “show-through” on an upper surface of the paper. In this case, a user may determine that an abnormality detection level should be changed to a low sensitivity in order to prevent “show-through” from being falsely detected as an abnormality. On the other hand, even if the same image is formed on the lower surface of the paper, in a case where the paper is thick, “show-through” itself does not occur on the upper surface of the paper. Therefore, a user can determine that it is not necessary to change an abnormality detection level.

In addition, as the size, paper type, basis weight, gloss, and the like of paper change, conspicuity of an abnormality may change. For example, even if an abnormality has the same size as another abnormality, in a case where the size of paper is sufficiently larger than the abnormality, a user may determine that the abnormality is not conspicuous and can tolerate the abnormality. On the other hand, in a case where the size of paper is relatively small, a user may determine that the abnormality is conspicuous and is unlikely to tolerate the abnormality. Therefore, it is necessary to change an abnormality detection level according to the size, paper type, basis weight, gloss, and the like of paper.

Therefore, in the fourth embodiment, the searcher 525 executes a search process on the basis of paper setting information set in a print job to be executed. Specifically, the paper setting information used in a print job corresponding to a sample image is stored in the database 555 in association with a sample image as a feature parameter.

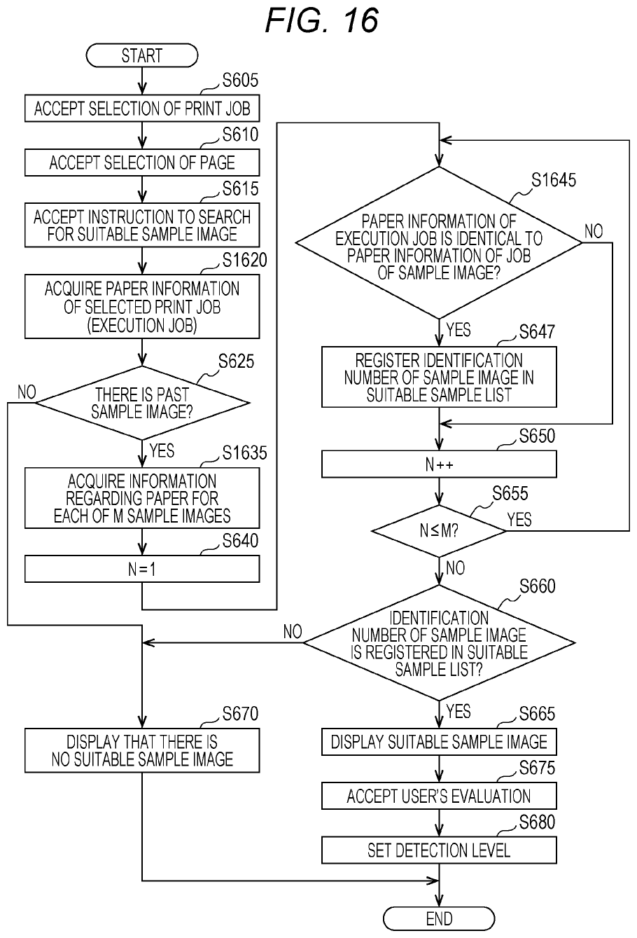

Hereinafter, a process executed by the CPU of the image inspection device 102 in the fourth embodiment will be described with reference to FIG. 16.

FIG. 16 is a flowchart illustrating an example of a procedure for setting an image abnormality detection level in the image forming system 170 of the fourth embodiment. In an aspect, the process illustrated in FIG. 16 is implemented by execution of a process program stored in the ROM by the CPU of the image inspection device 102.

In addition, the same process as that described above is designated by the same step number. Therefore, description of the same process will not be repeated.

First, the CPU executes processes from step S605 to step S615 of FIG. 7. In step S615, the CPU accepts an instruction to search for a suitable sample image for a selected page on the basis of a user operation via the operation panel 130.

In a subsequent step S1620, the CPU acquires paper information of a print job selected in step S605. The paper information is a feature parameter regarding paper for the job, and includes at least one of the basis weight, size, and paper type of the paper. In addition, the paper information may include a physical property value of the paper, such as the surface property, paper thickness, or basis weight of the paper. Here, the surface property represents a physical property of a surface of the paper, such as glossiness. Alternatively, the paper setting information may include a name given to the paper as described below.

A user can give a paper name to each type of paper used in a print job, and can register setting information including the basis weight, paper type, size, physical property value, and the like of the paper and the paper name in the auxiliary storage device 210 or the like as a paper profile while associating the setting information with the paper name. For example, it is assumed that data named “paper A” is registered in the paper profile. In addition, it is assumed that paper used in a print job to be executed is “paper A”. In this case, as the paper information in the print job to be executed, the CPU may acquire the paper name “paper A” as a feature parameter.

Thereafter, in step S625 of FIG. 7, the CPU determines whether or not a past sample image is stored in the storage 505. If the past sample image is stored in the storage 505, the CPU causes the process to proceed to step S1635.

In a subsequent step S1635, the CPU acquires information regarding paper for each of M sample images.

The paper information acquired for each sample image in step S1635 corresponds to the paper information acquired for the print job in step S1620. Thereafter, the CPU initializes the count number N for counting a sample image to be processed to 1 in step S640.

In a subsequent step S1645, the CPU determines whether or not paper information of a job to be executed is identical to paper information of a job of a sample image to be processed. If the paper information of the job to be executed is identical to the paper information of the job of the sample image (YES in step S1645), the CPU registers the identification number of the sample image in the suitable sample list 565 in step S647, and then causes the process to proceed to step S650. On the other hand, if the paper information of the job to be executed is not identical to the paper information of the job of the sample image (NO in step S645), the CPU causes the process to proceed to step S650.

There may be various methods for determining whether or not the paper information of the job to be executed is identical to the paper information of the job of the sample image to be processed, executed in step S1645.

For example, the CPU may determine whether or not the registered paper name of the paper of the job to be executed is identical to that of the job of the sample image to be processed (first determination process). The CPU may determine whether or not all the parameters related to the basis weight, size, and paper type of the paper of the job to be executed are identical to those of the job of the sample image to be processed (second determination process). In addition, the CPU may determine whether or not at least one of the parameters related to the basis weight, size, and paper type of the paper of the job to be executed is identical to that of the job of the sample image to be processed (third determination process). Alternatively, the CPU may determine whether or not at least one of physical property values of the paper of the job to be executed is identical to that of the job of the sample image to be processed (fourth determination process). Here, the fact that the physical property value of the paper of the job to be executed is identical to that of the job of the sample image to be processed includes that a difference between the physical property values thereof is within a measurement error range.

Priority may be set for the above first to third determination processes. For example, the CPU executes the first determination process for which the highest priority is set. In the first determination process, if the paper name of the paper of the job to be executed is identical to that of the job of the sample image to be processed, the CPU causes the process to proceed to step S647. As described above, in step S647, the CPU registers the identification number of the sample image in the suitable sample list 565. On the other hand, if the paper name of the paper of the job to be executed is not identical to that of the job of the sample image to be processed, the CPU executes the second determination process for which the second highest priority is set. In the second determination process, if all the parameters of the job to be executed are identical to those of the job of the sample image to be processed, the CPU causes the process to proceed to step S647. On the other hand, if not all the parameters of the job to be executed are identical to those of the job of the sample image to be processed, the CPU executes the third judgment process. In the third determination process, if at least one parameter of the job to be executed is identical to that of the job of the sample image to be processed, the CPU causes the process to proceed to step S647. On the other hand, no parameter of the job to be executed is identical to that of the job of the sample image to be processed, the CPU causes the process to proceed to step S650. In step S650, the CPU counts up the count number N.

In a subsequent step S655, the CPU repeats the process in step S1645 until the count number N becomes larger than M. If the count number N is larger than M (NO in step S655), the CPU causes the process to proceed to step S660.

Processes after a subsequent step S660 are similar to those in the case of FIG. 7. Therefore, detailed description thereof will not be repeated.

Note that although the fourth determination process is executed in step S1645, a physical property value of paper used in a print job thereof is not registered in some cases. In this case, the CPU may display a message for prompting a user to measure the physical property value of the paper on the operation panel 130. For example, the user can acquire a physical property value of the paper measured by an external media sensor (not illustrated) and register the physical property value in a paper profile. In another aspect, the user can perform a test print, acquire a physical property value of the paper measured by a media sensor 112, and register the physical property value in a paper profile.

[Effect of Fourth Embodiment]

In the image forming system 170 according to the fourth embodiment, the CPU of the image inspection device 102 acquires information regarding paper as a feature parameter of a print job selected by a user. Sample image data is stored in the database 555 in association with information regarding paper for a corresponding print job. On the basis of the acquired information regarding the paper, the searcher 525 searches the database 555 for information regarding the paper, the information being identical to the acquired information. The CPU displays a suitable sample image associated with the found information regarding the paper on the display 510. The CPU changes an abnormality detection level on the basis of evaluation for the suitable sample image input by a user. This makes it possible to reflect user's tolerance for an abnormality, which may change depending on the basis weight, size, paper type, physical property value, and the like of paper on which a printed image is formed, in the abnormality detection level.

### Fifth Embodiment

An image forming system 170 of a fifth embodiment is different from the image forming system 170 of the first embodiment described above in that the CPU of the image inspection device 102 searches the database 555 for a user name that is identical to the user name of a print job to be executed.

Note that the hardware configuration of the image forming system 170 of the fifth embodiment is similar to the hardware configuration in the case of the first embodiment illustrated in FIGS. 1 to 4. In addition, the functional configuration in the image forming system 170 of the third embodiment is basically similar to the functional configuration illustrated in FIG. 5. Therefore, the same or corresponding parts are designated by the same reference numeral, and description thereof will not be repeated.

In the first to fourth embodiments, a user may evaluate a sample image of a print job different from a print job executed by the user himself/herself. On the other hand, a user may desire to set an abnormality detection level in a print job to be executed by using a sample image of a print job that the user executed in the past. Therefore, in the fifth embodiment, the searcher 525 executes a search process on the basis of a user name as a feature parameter of a print job to be executed. Specifically, the user name of a print job corresponding to a sample image is stored in the database 555 as a feature parameter.

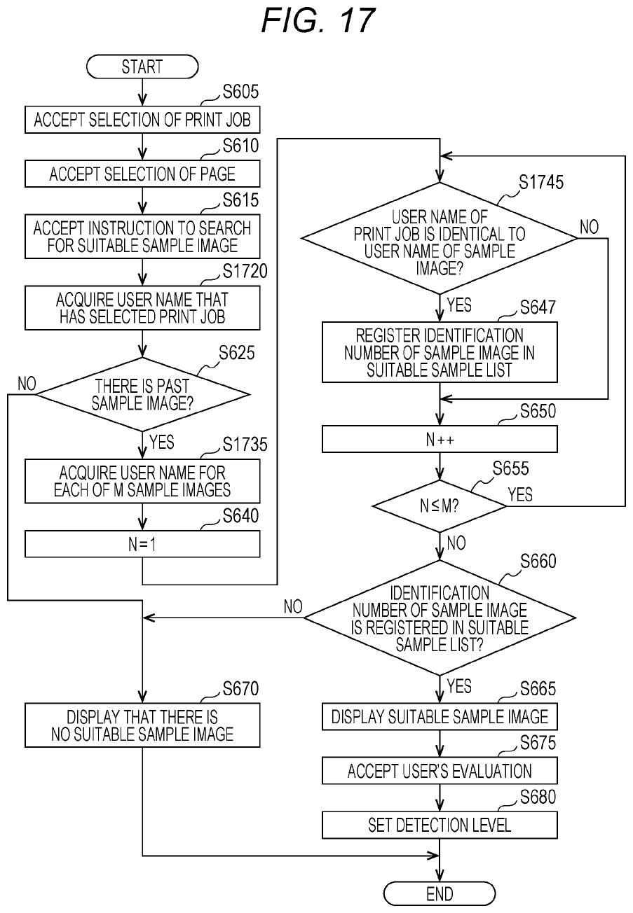

Hereinafter, a process executed by the CPU of the image inspection device 102 in the fifth embodiment will be described in detail with reference to FIG. 17.

FIG. 17 is a flowchart illustrating an example of a procedure for setting an image abnormality detection level in the image forming system 170 of the fifth embodiment. In an aspect, the process illustrated in FIG. 17 is implemented by execution of a process program stored in the ROM by the CPU of the image inspection device 102. Note that the same process as that illustrated in the flowchart of FIG. 7 is designated by the same step number, and therefore description of the process will not be repeated.

First, the CPU executes processes from step S605 to step S615 of FIG. 17. In step S615, the CPU accepts an instruction to search for a suitable sample image from a user.

In a subsequent step S1720, the CPU acquires a user name that has selected a print job in step S605.

In a subsequent step S625, the CPU determines whether or not there is a past sample image. If there is a past sample image, the CPU causes the process to proceed to step S1735. On the other hand, if there is no past sample image, the CPU displays that there is no suitable sample image on the operation panel 130 in step S670, and then ends a series of processes.

In a subsequent step S1735, the CPU acquires a user name for each of M sample images.

Next, the CPU initializes the count number N for counting a sample image to be processed to 1.

In a subsequent step S1745, the CPU determines whether or not the user name associated with a sample image to be processed is identical to the user name of a job to be executed. If it is determined that the user name associated with a sample image to be processed is identical to that of a job to be executed (YES in step S1745), the CPU registers the identification number of the sample image in the suitable sample list 565 in step S647 of FIG. 7, and then causes the process to proceed to step S650. On the other hand, if it is determined that the user name associated with a sample image to be processed is not identical to that of a job to be executed (NO in step S1745), the CPU causes the process to proceed to step S650.

Ina subsequent step S650, the CPU counts up the count number N. Ina subsequent step S655, the CPU repeats the process in step S745 until the count number N becomes larger than M. If the count number N is larger than M (NO in step S655), the CPU causes the process to proceed to step S660.

Subsequent processes in steps S660 to S680 are similar to those of FIG. 7, and therefore description thereof will not be repeated.

[Effect of Fifth Embodiment]

In the image forming system 170 according to the fifth embodiment, the searcher 525 searches the database 555 for a user name as a feature parameter of a print job to be executed. Sample image data is stored in the database 555 in association with the user name. As a result, a sample image whose user name is identical to that of the print job to be executed can be displayed on the display 510. As a result, a user can set an abnormality detection level in the print job to be executed by using a sample image of a print job that the user himself/herself executed.

[Modification]

The first to fifth embodiments may be appropriately combined with each other.

For example, in a case where the first embodiment is combined with the fourth embodiment, the storage 550 stores, as feature parameters, the ratio of each image area according to an attribute and information regarding paper related to a print job. After step S635 of FIG. 7 of the first embodiment, the CPU executes step S1635 of FIG. 16 of the fourth embodiment. Furthermore, if YES in step S645 of FIG. 7, the CPU further makes a determination for step S1645 of FIG. 16. When both conditions in step S645 and step S1645 are satisfied, the CPU registers the identification number of a sample image in the suitable sample list 565 in step S647.

In a case where the first embodiment is combined with the fifth embodiment, the storage 550 stores, as feature parameters, the ratio of each image area according to an attribute and the user name of a print job. After step S635 of FIG. 7 of the first embodiment, the CPU executes step S1735 of FIG. 17 of the fifth embodiment. Furthermore, if YES in step S645 of FIG. 7, the CPU further makes a determination for step S1745 of FIG. 17.

When both conditions in step S645 and step S1745 are satisfied, the CPU registers the identification number of a sample image in the suitable sample list 565 in step S647.

Although embodiments of the present invention have been described and illustrated in detail, the disclosed embodiments are made for purposes of illustration and example only and not limitation. The scope of the present invention should be interpreted by terms of the appended claims and intends to include all modifications within meaning and scope equivalent to the claims

What is claimed is:

1. An image forming system comprising:
an image former that forms a printed image on a recording medium on the basis of setting information included in a print job and original image data;
an image reader that generates read image data by optically reading the printed image;
an abnormality detector that detects an abnormality included in the printed image using the read image data;
a storage that stores a plurality of pieces of read image data in each of which the abnormality has been detected as sample image data, and stores at least one feature parameter representing a feature of the print job in association with corresponding sample image data;
a hardware processor that searches for a feature parameter that is similar or identical to a feature of a print job to be executed from the plurality of feature parameters stored in the storage and sets an abnormality detection level in the abnormality detector on the basis of the user's evaluation;
a display that displays sample image data associated with the found feature parameter; and
an acceptor that accepts user's evaluation for an abnormality included in the displayed sample image data.

2. The image forming system according to claim 1, wherein the at least one feature parameter includes a parameter representing a feature of original image data of a corresponding print job.

3. The image forming system according to claim 2, wherein
a bitmap format image based on the original image data is divided into a plurality of image areas having different attributes from each other, and
the at least one feature parameter includes a ratio of each of the plurality of image areas as a parameter representing a feature of the original image data.

4. The image forming system according to claim 3, wherein
the storage further stores information that specifies an image area in which an abnormality has been detected among the plurality of image areas in association with each of the plurality of pieces of sample image data,
the acceptor accepts designation of the image area in which an abnormality has been detected from the user, and
the hardware processor searches for sample image data that is identical or similar to a ratio of each image area of a print job to be executed and includes an abnormality in the image area designated by the user, and causes the display to display the sample image data.

5. The image forming system according to claim 1, wherein the at least one feature parameter includes a parameter relating to paper as the recording medium, the parameter being defined as the setting information of a corresponding print job.

6. The image forming system according to claim 5, wherein the parameter relating to the paper includes at least one of a basis weight, size, and paper type of the paper.

7. The image forming system according to claim 5, wherein the parameter relating to the paper includes a physical property value of the paper.

8. The image forming system according to claim 1, wherein the at least one feature parameter includes a user name that has performed a corresponding print job.

9. An image inspection device comprising:
an image reader that generates read image data by optically reading a printed image that an image former has formed on a recording medium according to a print job including setting information and original image data;
an abnormality detector that detects an abnormality included in the printed image using the read image data, and causes a storage to store read image data in which the abnormality has been detected as sample image data,
the abnormality detector causing the storage to store at least one feature parameter representing a feature of a corresponding print job in association with each of the plurality of pieces of sample image data stored in the storage; and
a hardware processor that searches for a feature parameter that is similar or identical to a feature of a print job to be executed from the plurality of feature parameters stored in the storage, and causes a display to display sample image data associated with the found feature parameter and
accepts user's evaluation for an abnormality included in the displayed sample image data and sets an abnormality detection level in the abnormality detector on the basis of the user's evaluation.

10. An abnormality detection level setting method in an image inspection device,
the image inspection device including:
an image reader that generates read image data by optically reading a printed image that an image former has formed on a recording medium according to a print job including setting information and original image data; and
a hardware processor, and
the abnormality detection level setting method comprising:
the hardware processor detecting an abnormality included in the printed image using the read image data, and causing a storage to store read image data in which the abnormality has been detected as sample image data;
the hardware processor further causing the storage to store at least one feature parameter representing a feature of a corresponding print job in association with each of the plurality of pieces of sample image data stored in the storage;
the hardware processor searching for a feature parameter that is similar or identical to a feature of a print job to be executed from the plurality of feature parameters stored in the storage;
the hardware processor causing a display to display sample image data associated with the found feature parameter;
the hardware processor accepting user's evaluation for an abnormality included in the displayed sample image data; and
the hardware processor setting the abnormality detection level on the basis of the user's evaluation.

11. A non-transitory recording medium storing a computer readable program to implement an abnormality detection level setting method in an image inspection device, wherein
the image inspection device comprises
an image reader that generates read image data by optically reading a printed image that an image former has formed on a recording medium according to a print job including setting information and original image data, and
the abnormality detection level setting method causes a computer to execute:
detecting an abnormality included in the printed image using the read image data, and causing a storage to store read image data in which the abnormality has been detected as sample image data;
further causing the storage to store at least one feature parameter representing a feature of a corresponding print job in association with each of the plurality of pieces of sample image data stored in the storage;
searching for a feature parameter that is similar or identical to a feature of a print job to be executed from the plurality of feature parameters stored in the storage;
causing a display to display sample image data associated with the found feature parameter;
accepting user's evaluation for an abnormality included in the displayed sample image data; and
setting the abnormality detection level on the basis of the user's evaluation.
